(19) United States
(12) Patent Application Publication
(10) Pub. No.: US 2008/0173840 A1
(43) Pub. Date: Jul. 24, 2008

(54) Electropneumatic Cartridge Valve in Particular For Use as a Pilot Valve in a Slimline Pneumatic Valve for a Compact Valve Unit

(76) Inventors: Heinz Godert, Ludwigsburg (DE); Karl Troltsch, Schwieberdingen (DE)

Correspondence Address: JACKIE JAY SCHWARTZ, 1350 Broadway, Suite 1510, NEW YORK, NY, 10018, US

(21) Appl. No.: 11/911,924

(22) PCT Filed: Apr. 28, 2006
(86) PCT No.: PCT/EP06/61918

§ 371 Date: Oct. 18, 2007

(30) Foreign Application Priority Data
Apr. 28, 2005 (DE) 10 2005 020 278.0

(51) Int. Cl. F16K 31/06; H01F 7/08; F16K 27/00

(52) U.S. Cl. 251/129.15; 137/487.5

(57) ABSTRACT

Disclosed is a pneumatic cartridge valve, especially for use as a pilot valve in a slimline pneumatic valve (1) for a compact valve unit. Said pneumatic cartridge valve has a drive part (2a) comprising an electromagnetic coil (3) for operating a valve part (2b) with a round cross section and has external pressurized-air ports (6). Said pressurized-air ports (6) extend to the outside in the area of the cylindrical outer surface of the valve part (2b). The drive part (2a), unlike the valve part (2b), has an essentially rectangular cross section, wherein the length (B) of its shorter side is determined by the winding diameter of the electromagnetic coil (3).

The present invention relates to an electropneumatic cartridge valve, in particular for use as a pilot valve in a slimline pneumatic valve for a compact valve unit, having a drive part including an electromagnetic coil, which actuates a valve part having a round cross section and at least two external pressurized-air ports.

The field of use of the present invention primarily extends to slimline pneumatic valves which, arranged in series and side by side, form a valve unit essentially in the form of a rectangular parallelepiped. Such a valve unit has the advantage that the feeding pressure supply and the venting of the exhaust air produced by the individual pneumatic valves can be centralized. The valve unit is the more compact the more slimline the individual pneumatic valves are designed. With pneumatic valves used for the present purpose, two alternative design principles of pilot valves are generally known which have the object to generate, based on an electric driving signal, a corresponding pneumatic control pressure to switch the pneumatic valve. On the one hand, a pilot valve may be designed as a yoke type valve which is mostly releasably fixed on the body of the pneumatic valve by means of bolts. Alternatively it is also possible to form the pilot valve as a cartridge valve, which is accommodated in a corresponding recess in the body of the pneumatic valve. The present invention is directed to this latter type of construction.

In pneumatic valves for the construction of a valve unit which is as compact as possible, the minimum structural width of each pneumatic valve is the primary optimization criterion. It is therefore a continuous design objective to realize as many switching functions as possible within a limited space to thereby enable a very compact structure of the valve unit to be achieved.

The structural width of a pneumatic valve in turn is primarily determined by the structural width of the pilot valve. Since the pilot valves used are primarily of the electromagnetic type, the physical conditions of this actuator principle must be taken into account in the optimization of the structural width. The actuation force generated by the actuator, in particular, is determined by the magnetic induction achievable in the working air gap and by the cross sectional area of the armature in the area of the working air gap.

The achievable magnetic induction is defined not only by the available cross sections for the magnetic flux conduction and the characteristics of the materials used in the magnetic circuit, but also by the ampere-turn value of the electromagnetic coil. Since the admissible power consumption of miniaturized pilot valves is limited to very low values, in particular for reasons of thermal stress, the number of turns in the electromagnetic coil and the cross-sectional area of the working air gap should be chosen to be as large as possible to achieve an optimum force configuration of the pilot valve.

From DE 201 20 608 U1, a generic pneumatic cartridge valve is known, which can also be used as a pilot valve. The prior art cartridge valve essentially has an overall cylindrical shape, wherein the drive part containing the electromagnetic coil together with the valve part containing the valve mechanics results in an essentially cylindrical outer contour which only has small variations in diameter over its axial length and which is configured to be inserted in a recess formed as a stepped bore on the side of the body of a pneumatic valve, to be used there as a pilot valve.

The drive part of the cartridge valve comprising the electromagnetic coil has an outer sheath of a ferrous metal serving to recycle the magnetic flux. The sheath further completely surrounds the electromagnetic coil integrated therein and therefore also has a housing function. For corrosion protection, the sheath is provided with a coating of plastic material. This construction entails that the usable winding window of the electromagnetic coils is limited on the outside by the wall thickness of the sheath plus coating and by the required distance between the outer diameter of the winding of the electromagnetic coil and the inner diameter of the sheath. Furthermore, annular grooves are provided in the area of the valve part to receive sealing rings. A drawback of this prior art is that the outer diameter of the known pneumatic cartridge valve is in effect quite large, so that it is unsuitable, in particular, for slimline valve bodies of the initially mentioned type. With the continued miniaturization of cartridge valves of the known structural type, the available actuating force of the actuator becomes ever smaller.

It is therefore an object of the present invention to provide a pneumatic cartridge valve providing relatively high switching power relative to its structural size and which may be integrated in slimline pneumatic valves in a space-saving manner.

This object is solved on the basis of a pneumatic cartridge valve according to the preamble of claim 1 in combination with its characterizing features. The subsequent dependent claims define advantageous embodiments of the invention.

The present invention includes the technical teaching that the pressurized-air ports extend to the outside in the area of the cylindrical outer surface of the valve part and that the drive part, unlike the valve part, has a substantially rectangular cross section wherein the length B of the shorter sides is determined by the winding diameter of the coil.

The advantage of the approach according to the present invention results from the particular shape of the pneumatic cartridge valve. The drive part which is critical in the optimization of the structural space may be accommodated in a corresponding rectangular recess at a narrow side of a slimline pneumatic valve in a simple and space-saving manner, wherein the pressurized-air ports may also be coupled to the cartridge valve in a space-saving manner. A pneumatic cartridge valve to be used as a pilot valve usually has a three-way, two-position function, enabling a feeding pressure port, a venting port and a working port for the control pressure to be provided as pressurized-air ports. The space saving construction of the cartridge valve according to the present invention results from the fact that the drive part is designed such that the outer diameter of the electromagnetic coil extends to the full width of the space provided by the body of the pneumatic valve.

Compared to the usual construction of cartridge valves with cylindrical drive, the construction according to the present invention has a substantially higher winding window of the electromagnetic coil which enables substantially higher flux rates with the same armature diameter and length. This effect which is particularly noticeable with miniaturized electromagnetic valves results in a substantial increase in the potential force of the actuator. The design of a pneumatic cartridge valve according to the present invention is optimized with respect to the structural width B of the corresponding recess, which leads to only a small increase in the structural height. An increase in this dimension is not critical, however, for the compactness of a slimline pneumatic valve forming a valve unit and can be partially compensated by structural measures in the area of the base plates. The rectangular cross section of the valve drive which could be seen as a structural drawback for integration, is uncritical, in particular, for the use with pneumatic valves, because the valve housings are usually injection molded, which means that a rectangular recess can be simply realized in manufacture. In particular with slimline pneumatic valves, which are manufactured on an industrial scale, the body is usually not formed as a mechanically machined housing bore, but as an injection molded part of plastic material. Manufacturing the rectangular recess in the body of the pneumatic valve corresponding to the cartridge valve of the present invention does therefore not cause any problems.

According to an embodiment for improving the present invention, it is provided that a flux-conducting portion of the outer magnetic circuit of the electromagnetic coil is formed as a U-shaped yoke. The yoke extends adjacent to the two shorter sides B of the rectangular cross section i.e. in an area in which there is sufficient structural space. The outer magnetic circuit necessary for the functioning of the electromagnetic actuator, unlike the prior art, is thus not configured as a cylindrical sheath or the like. In dimensioning the wall thickness of the yoke replacing the sheath, care should be taken that the cross-sectional area is equivalent to the sheath to ensure adequate conduction of the magnetic flux.

It is conceivable to seal the air gap between the electromagnetic coil and the corresponding recess in the body of the cartridge valve with a setting cast substance to create axial guidance and a heat bridge to the body of the cartridge valve. Filling the open electromagnetic coil in the body of the cartridge valve with cast material has the advantage, over and above the configuration as a conventional cylindrical encapsulated cartridge valve, that no air layer is present between the electromagnetic coil and the outer sheath which would block heat transfer. Since coil heat is one of the central problems in the configuration of a miniaturized pilot valve, such positive dissipation of the waste heat of the electromagnetic coil is of particular importance.

According to another embodiment improving the present invention, it is provided that the U-shaped yoke, which forms the outer magnetic circuit of the drive part, has a bore to receive a cylindrical magnet core in the area of its vertex. This bore allows the magnet core, otherwise fixed with respect to the electromagnetic coil, to be at first arranged in an axially displaceable manner, so that it may be fixed relative to a coaxially adjacent magnet armature, moveable with respect to the fixed magnet core, only after it has been adjusted.

Preferably the two legs of the yoke, apart from conducting the magnetic flux, also serve as a mechanic link between the drive part and the pneumatic control part. Said yoke may be simply manufactured as a stamped and bent part, wherein pins for establishing electrical contact with the ends of the electromagnetic coil may be configured as breakaway portions in the counter direction to the direction of the legs. For securing the connection between the drive part and the valve part, it can be provided that both ends of the legs of the yoke curl radially to the inside in order to create a releasable lock with the valve part. The shape of this type of hook on the end of the two legs of the yoke can be used to generate an axial force component ensuring axial pressing of structural elements contained in the drive part against the area surrounding the bore of the yoke. By this additional measure an axial bias can be generated by interposed elastomeric 0-rings allowing manufacturing tolerances to be simply compensated. It is also possible, however, instead of the hook-shaped ends of the legs of the yoke, to realize joining of the components contained in the drive part by seaming, pressing or the like.

Further embodiments to improve the present invention will be illustrated together with the description of a preferred exemplary embodiment of the invention with respect to the drawings, in which:

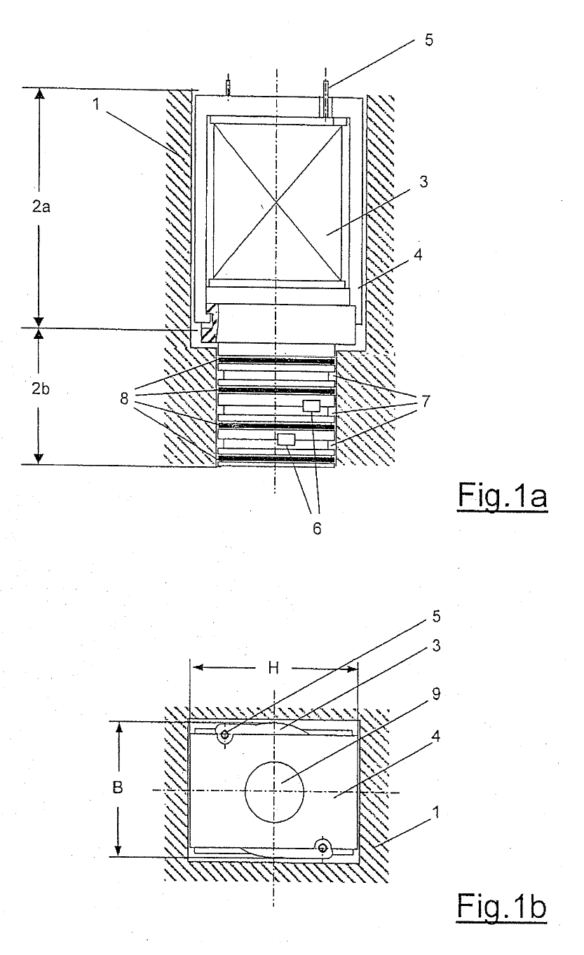

FIG. 1a is a side view of a pneumatic cartridge valve assembled in a corresponding recess on the side of a pneumatic valve,

FIG. 1b is a plan view of the assembled cartridge valve according to FIG. 1a, and

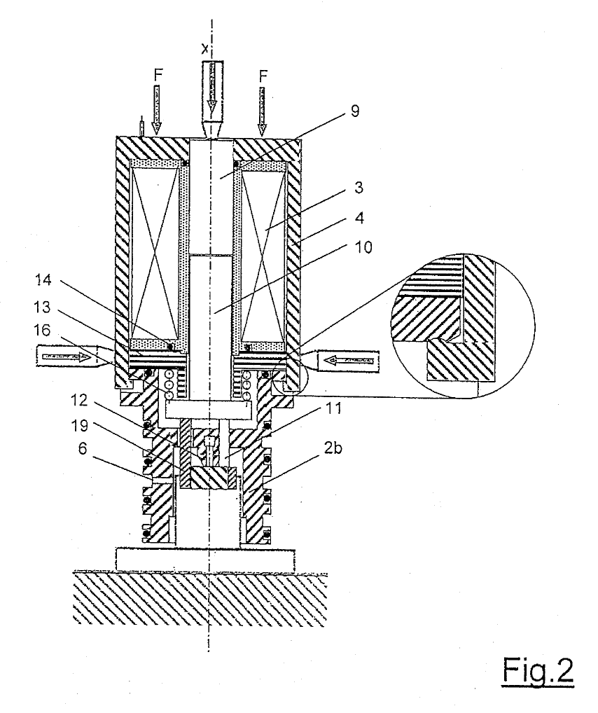

FIG. 2 is a longitudinal sectional view of the cartridge valve with means for adjusting.

According to FIG. 1a the body of a pneumatic valve 1 has a recess in which the pneumatic cartridge valve consisting of a drive part 2a and a valve part 2b is assembled. Drive part 2a essentially consists of an electromagnetic coil 3 surrounded by a U-shaped yoke 4 as a flux conducting part of the outer magnetic circuit. The electric connection of electromagnetic coil 3 is via a connection pin 5 coupled to each coil end.

Valve part 2b of the pneumatic cartridge valve has a round cross section and is provided with a plurality of annular channels 7 into which pressurized-air ports 6 open out. To seal annular channels 7 for pressurized-air ports 6 amongst each other, several sealing rings 8 are arranged in between, which contact the body of pneumatic valve 1 in a sealing manner.

According to FIG. 1b, drive part 2a, unlike valve part 2b, has an essentially rectangular cross section having a shorter side B and a longer side A. The winding diameter of electromagnetic coil 3 obviously determines the length of the shorter side B of drive part 2a. Electromagnetic coil 3 is accommodated in the corresponding recess on the side of pneumatic valve 1 in an unencapsulated state. U-shaped yoke 4 of a ferrous metallic material has a bore in the area of its vertex to receive a cylindrical magnet core 9 which is at first axially displaceably arranged within the bore and only fixed after it has been adjusted.

According to FIG. 2, adjacent to magnet core 9 fixed with respect to yoke 4, a moveable armature 10 is provided, which has a rod 11 to operate a valve seat 12 according to the energized state of electromagnetic coil 3 in an axial direction.

The two legs of U-shaped yoke 4, in addition to the conduction of the magnetic flux, also serve as a mechanical link between drive part 2a and valve part 2b. This is because due to the magnetic flux there is a force component in the area of the ends of the two legs of yoke 4 which is perpendicular to the leg surface radially to the inside (as indicated by arrows) so that a clamping force is generated acting on valve part 2b arranged between the two ends of yoke 4. Moreover the two ends of the legs of yoke 4 curl radially to the inside to form a locking configuration with valve part 2a (see enlarged detail). The form of the ends of yoke 4 curling to the inside, ensures axial pressing of components clamped within drive part 2b, such as pole plate 13, which presses against the housing of electromagnetic coil 3 via a tolerance-compensating sealing ring 14, to thus generate an axial biasing force.

After completion of the assembly of the pneumatic cartridge valve, it has to be adjusted. Adjusting the cartridge valve is aimed at compensating manufacturing tolerances and adjusting the stroke of moveable magnet armature 10 in such a way that it is precisely matched to the stroke required to operate valve seat 12. Such adjustment has the result that practically no stroke reserve is required for drive part 2a which enables a power-optimized configuration of the electromagnetic converter. The driving characteristic can be designed in such a way that a high power potential due to an extremely small armature stroke of 0.2 mm and less results.

Despite these stringent requirements as to the precision of the overall system (tolerance chains) due to this small armature stroke, because of the adjustment process described in the following, the manufacturing tolerances of the components used are relatively uncritical. To perform the adjustment, the complete drive part and the top portion of the valve housing associated with it, are fitted over a cylindrical device 15 in which the sealing element with the operating fork has been inserted. Rods 11 of the actuating fork come into engagement with recesses in the valve housing and are supported on the end surface of the moveable magnet armature facing them. The sealing element is pressed onto valve seat 12 with a predefined force F axially fed into the drive, so that the seat is securely sealed with a predetermined bias.

The adjustment itself is carried out by axially displacing magnet core 9 to be fixed within U-shaped yoke 4. Magnet core 9 is displaced in the X direction until the end surface of magnet core 9 contacts adjacent moveable magnet armature 10 so that the working air gap becomes zero.

Magnet core 9 is then fixedly joined to yoke 4 in this position by a corresponding joining method, such as laser welding, clamping etc. As a result, the drive is adjusted in the operated switch position on valve seat 12.

This is why the adjustment of valve seat 12 is substantially less critical and can be covered by structural configuration alone due to the simple tolerance chain.

1. An electropneumatic cartridge valve, in particular for use as a pilot valve in a slimline pneumatic valve for a compact valve unit, having a drive part comprising an electromagnetic coil and having an essentially rectangular cross section, wherein the length of the shorter side is determined by the winding diameter of the electromagnetic coil 3 which operates with a round cross section and having external pressurized-air ports,
wherein at least part of the pressurized-air ports extend to the outside in the area of the cylindrical outer surface of the valve part, wherein a flux-conducting portion of the outer magnetic circuit of the electromagnetic coil is configured as a U-shaped yoke having its legs connected with a pole plate in the area of their ends.

2. (canceled)

3. The electropneumatic cartridge valve according to claim 1, wherein the electromagnetic coil is accommodated in a corresponding recess of the pneumatic valve at least surrounding the valve part in an unencapsulated state.

4. The electropneumatic cartridge valve according to claim 3, wherein the air gap between the electromagnetic coil and the recess of the pneumatic valve is sealable with a setting cast substance.

5. The electropneumatic cartridge valve according to claim 1, wherein the flux conducting portion of the outer magnetic circuit of the electromagnetic coil has a bore to receive a cylindrical magnet core in the area of its vertex.

6. The electropneumatic cartridge valve according to claim 5, wherein the magnet core is axially displaceably arranged within the bore so that the magnet core is only fixed after it has been adjusted relative to a moveable magnet armature arranged coaxially adjacent to it.

7. The electropneumatic cartridge valve according to claim 2, wherein the two legs of the yoke in addition to conducting the magnetic flux, also serve as a mechanical link between the drive part and the valve part.

8. (canceled)

9. The electropneumatic cartridge valve according to claim 7, wherein the two ends of the legs of the yoke are curled radially to the inside to create a strong connection with the valve part.

10. The electropneumatic cartridge valve according to claim 9, wherein the form of the ends of the yoke curled radially to the inside ensures axial pressing of the components clamped hereby and present in the drive part.
